(19) United States
(12) Patent Application Publication
(10) Pub. No.: US 2012/0261333 A1
(43) Pub. Date: Oct. 18, 2012

(54) FILTER ELEMENT FOR FLUID FILTRATION SYSTEM

(76) Inventors: Shane James Moran, Wilmington, NC (US); Peter Alan Hajek, Burlington, NC (US); Dennis David Leet, Wilmington, NC (US); Steven Alton Stansell, Harrisburg, PA (US)

(21) Appl. No.: 13/446,509

(22) Filed: Apr. 13, 2012

Related U.S. Application Data
(60) Provisional application No. 61/474,838, filed on Apr. 13, 2011.
(60) Provisional application No. 61/497,594, filed on Jun. 16, 2011.

(51) Int. Cl. B01D 69/04

(52) U.S. Cl. 210/500.23

(57) ABSTRACT

A filter element for use in a reverse osmosis, nano-filtration, membranes and spacers membrane-bioreactor, forward osmosis, or other filtration system, includes a permeate carrier substrate having a wrapped core tube. The permeate carrier includes a series of spaced ribs. The ribs are formed by application of yarns, strings or resinous or polymeric materials to a membrane substrate. The ribs define channels for passage of a liquid or gas permeate therealong. The permeate is received at the core tube which has one or more elongated flow recesses therealong to facilitate collection of the permeate.

### CROSS REFERENCE TO RELATED APPLICATIONS

The present Patent Application is a formalization of previously filed, co-pending U.S. Provisional Patent Application Ser. No. 61//474,838, filed Apr. 13, 2011 and U.S. Provisional Patent Application Ser. No. 61/497,594, filed Jun. 16, 2011 by the inventors named in the present Application. This Patent Application claims the benefit of the filing date of these cited Provisional Patent Applications according to the statutes and rules governing provisional patent applications, particularly 35 U.S.C. § 119(a)(i) and 37 C.F.R. § 1.78(a)(4) and (a)(5). The specification and drawings of the Provisional Patent Applications referenced above are specifically incorporated herein by reference as if set forth in their entireties.

### FIELD OF THE INVENTION

The present invention generally relates to systems and methods for filtration of liquids, gases and other fluid materials, and in particular, the present invention relates to filter element having a cross-flow core tube with permeate carrier sheet materials wound thereabout, and methods of forming such materials for use in fluid filtration systems to facilitate the removal of filtered fluids from such fluid filtration system.

### BACKGROUND OF THE INVENTION

In fluid filtration systems, such as nano-filtration, ultra filtration, forward osmosis, reverse osmosis filtration systems, and other, similar filtration and/or liquid or gas transference processes, a fluid material such as water or other liquid generally is passed through a filter element in which the liquid is cleaned of particulates and other contaminant materials that may be contained therein. For example, in reverse osmosis type filtration systems, a filter element generally is received within a pressure vessel having one or more flow tubes at an inlet side for the pressure vessel. The flow tubes provide an inlet for feed water or other fluid materials to be cleaned to be introduced into the filter element. The filter element itself generally includes a spiral wound membrane filtration element, which typically includes a permeate carrier sheet materials between two layers of a semi-permeable membrane material within the membrane surfaces thereof facing away from the permeate carrier sheet materials, forming a “leaf” structure. This leaf structure generally is closed on three sides, and is wound about a core tube to form the filter element. The outside of the leaf structure generally is at a feed pressure of the incoming fluid while the inside of the leaf structure is at atmospheric pressure.

The permeate carrier sheet materials of the filter element generally define a series of channels or grooves through which a permeate (the filtered liquid or other fluid material) will pass as the flow of fluid moves through the semi-permeable membranes, which filter particulates and other contaminant materials from the permeate. The permeate generally is drawn through the channels of the permeate carrier sheet materials and is fed to the centrally located core tube about which the filter element is wound. The core tube generally includes a series of holes spaced along its length for receiving the permeate or cleaned fluid, which enters the holes of the core tube and is directed along the central passage of the core tube and out of the filter element for collection.

In the past, conventional permeate carrier sheet materials generally have been made from a tricot material that comprises a knitted fabric material formed from epoxy or melamine coated polyester or similar coated yarn materials, typically formed on specialized knitting machines. The process of knitting the interconnected loops of such tricot materials also generally necessitates the use of finer denier yarns, which require more knitting more yarn due to the geometry of the stitch formation, and thus are inherently more costly to produce than fabrics utilizing identical polymers in heavier deniers. These tricot materials further generally are knitted in a series of longitudinally extending ribs defining channels therebetween and along which the permeate is guided toward the holes of the core tube. The core tubes of most conventional filtration systems, however, generally have included only a limited number of openings for receiving the cleaned water or other permeate material passing along the permeate carrier sheet material channels for collection. Such holes generally are widely spaced relative to the width of the channels of the permeate carrier sheet materials, and as a result, most permeate carrier sheet materials are required to have ribs that are somewhat porous and/or to include lateral flow channels that provide a cross flow path through the ribs as needed so that the permeate can reach the holes of the core tube. Permeate carrier sheet materials without such cross-flow functionality generally substantially restrict the flow of the permeate to the core and significantly reduce element flux within the filter element.

Accordingly, it can be seen that a need exists for a filter element having a core tube and permeate carrier sheet materials for use in filtration systems that addresses the foregoing and other related and unrelated problems in the art.

### SUMMARY OF THE INVENTION

Briefly described, the present invention generally relates to improvements in filter elements and components therefor, such as permeate carrier sheet materials and a cross-flow core tube structure, for use in fluid filtration systems such as reverse osmosis, nano-filtration, ultra filtration, forward osmosis and other, similar filtration and/or liquid or gas transference systems that facilitates the rapid and efficient removal of cleaned permeate flows. The cross-flow core tube is designed to fit within and provide support to a spiral wound or wrapped filtration element of the type generally including one or more membrane sheets having permeate carrier sheet materials and spacers arranged on opposite sides thereof and further enables the use of a wider variety of permeate carrier sheet materials. Other types of filter elements and filtration systems also can be utilized with the improved cross-flow core tube and permeate carrier sheet materials formed according to the principles of the present invention.

The cross-flow core tube generally will include an elongated tubular member including a cylindrical, rectangular or otherwise configured body with open first and second ends. At least one flow directing groove or flow recess generally will be formed along an intermediate portion of the tubular body between the first and second ends thereof. Typically, there will be two or more grooves or flow recesses formed along the body of the flow tube, with the grooves or flow recesses generally being formed at substantially equally spaced locations thereabout. Still further, in an alternative embodiment, shortened grooves or flow recesses of a reduced length can be formed along and about the tubular body at spaced locations in a preset or more randomly designed pattern as desired. The grooves or flow recesses of the cross-flow tube also generally will include a series of flow openings or ports arranged at spaced locations therealong. These ports or flow openings can be formed in different configurations and sizes and enable the fluid, such as cleaned water, to be directed into the flow tube from the ends of the flow channels of the permeate carrier sheet materials and to be directed away from the filter element for collection. In addition, the flow openings and the grooves can be replaced with a series of elongated slotted openings formed in spaced or varied patterns about the intermediate portion of the tubular body of the cross-flow core tube.

In addition, the filter element formed according to the principles of the present invention can further include permeate carrier sheet materials that are different in structure and method of formation from conventional tricot materials so as to create a more economical permeate carrier sheet material. Such permeate carrier sheet materials generally will include a series of ribs or wales that define spaced flow channels or grooves along which the filtered permeate fluid flow will be guided toward the flow recesses of the core tube. In one embodiment, such permeate carrier sheets can be formed by application of a series of yarns, strings, fibers, filaments or other types of rib materials to a substrate or base. The rib materials can be guided in spaced series into an overlying relationship onto a surface of the substrate and attached or affixed to the substrate, with the rib materials being maintained in their desired spacing across the surface of the substrate, such as by application of an adhesive or resin material applied to the ribs, the substrate, or both, either prior to or after the positioning of the rib materials on the substrate surface. Alternatively, the rib materials can be formed from an extruded synthetic or composite material, such as a resin material, applied in discrete, spaced lines forming the ribs, with the spaced channels defined therebetween. Still further, the rib materials can be applied to the substrate with or without an adhesive and thereafter heat set so as to weld or otherwise affix the rib materials to the substrate. The resultant permeate carrier sheet materials accordingly can be formed without requiring expensive yarns or other materials and specialized equipment therefor, and their formation can provide for enhanced control of the size, configuration and spacing of the rib materials and channels defined therebetween.

In use, the permeate liquid, such as cleaned water, generally will be directed along the longitudinal channels of the permeate carrier sheet materials and into the flow openings formed along the flow directing grooves or recesses of the cross-flow core tube as the influent liquid passes into the filter element. The elongated grooves or slotted recesses formed in the flow tube further will enable the permeate liquid to be collected from the longitudinal channels of the permeate carrier sheet materials and moved therealong for feeding to the flow openings or ports formed in such grooves, without requiring the permeate carrier sheet materials to be formed with additional laterally directed cross flow channels or porous ribs to provide for lateral flow of the fluid across the width of the permeate carrier sheet materials to reach one of the spaced flow openings of the flow tube. As a result, a variety of different configuration, type and constructions permeate carrier sheet materials also can be utilized for the filtration system.

Various objects, features and advantages of the present invention will become apparent to those skilled in the art upon a review of the following detailed description, when taken in conjunction with the accompanying drawings.

### BRIEF DESCRIPTION OF THE DRAWINGS

FIG. 1 is a perspective view of a filter element incorporating a cross-flow core tube, and permeate carrier sheet materials according to the principles of the present invention.

FIG. 2 is side elevational view of the cross-flow core tube according to one example embodiment of the present invention, with the surrounding filter element illustrated in phantom.

FIG. 3 is perspective illustration of an alternative embodiment of cross-flow core tube according to the principles of the present invention, incorporating reduced length flow recesses, slots and/or elongated flow openings at spaced locations therealong.

FIG. 4 is a perspective illustration of another alternative embodiment of the cross-flow core tube according to the principles of the present invention, incorporating ridges or ledges to direct the permeate to the flow openings of the core tube.

FIG. 5A is a photograph showing one example embodiment of a permeate carrier sheet materials formed according to the principles of the present invention.

FIG. 5B is a schematic example of another embodiment of a configuration of the permeate carrier sheet materials formed according to the principles of the present invention.

FIG. 6A is a schematic illustration of one example embodiment of a process for forming permeate carrier sheet materials according to the principles of the present invention.

FIG. 6B is a perspective view schematically illustrating an additional alternative embodiment of the process for forming permeate carrier sheet materials according to the principles of the present invention.

FIG. 6C is a perspective view schematically illustrating still a further embodiment of the process for forming permeate carrier sheet materials according to the present invention.

Those skilled in the art will appreciate and understand that, according to common practice, the various features of the drawings discussed below are not necessarily drawn to scale, and that the dimensions of various features and elements of the drawings may be expanded or reduced to more clearly illustrate the embodiments of the present invention described herein.

### DETAILED DESCRIPTION OF THE INVENTION

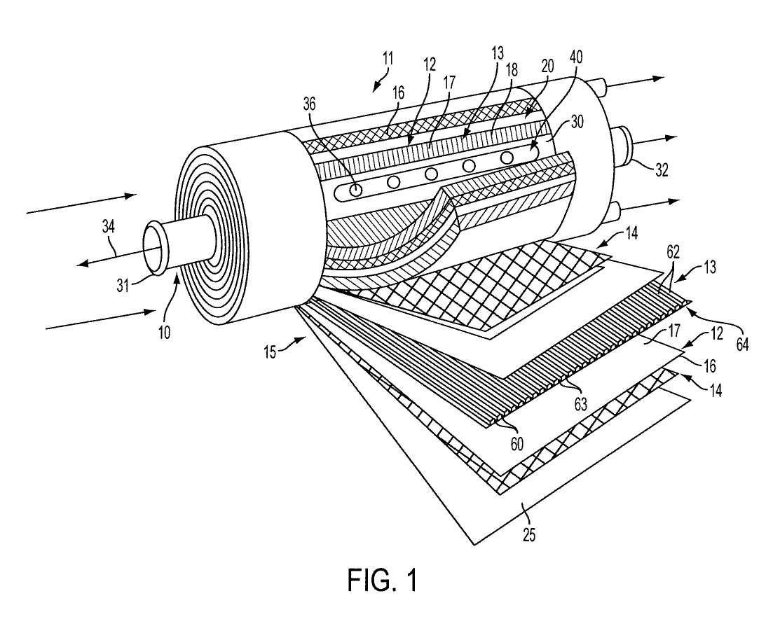

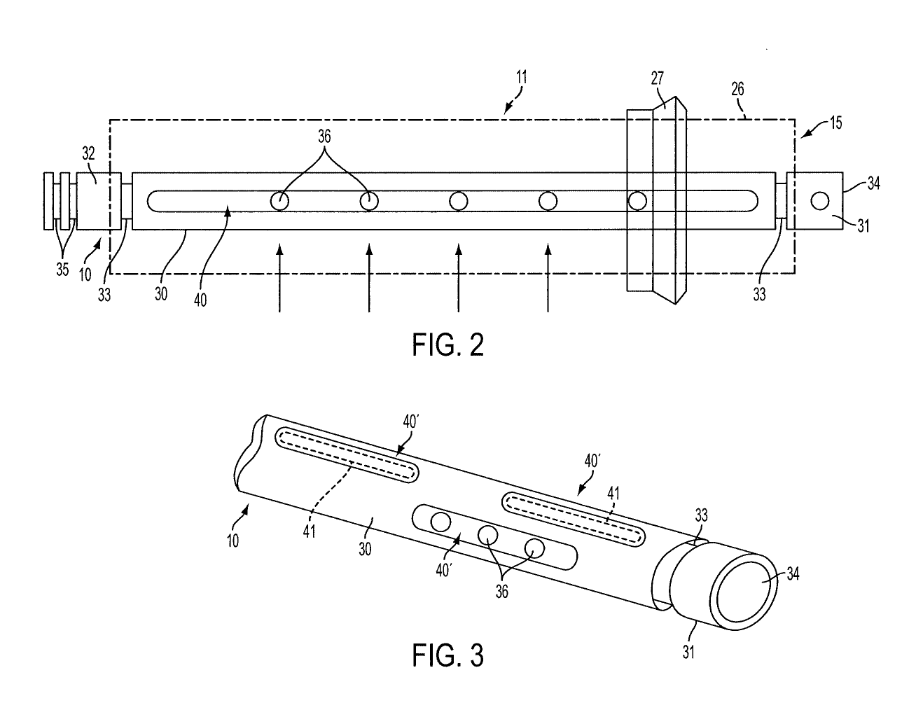

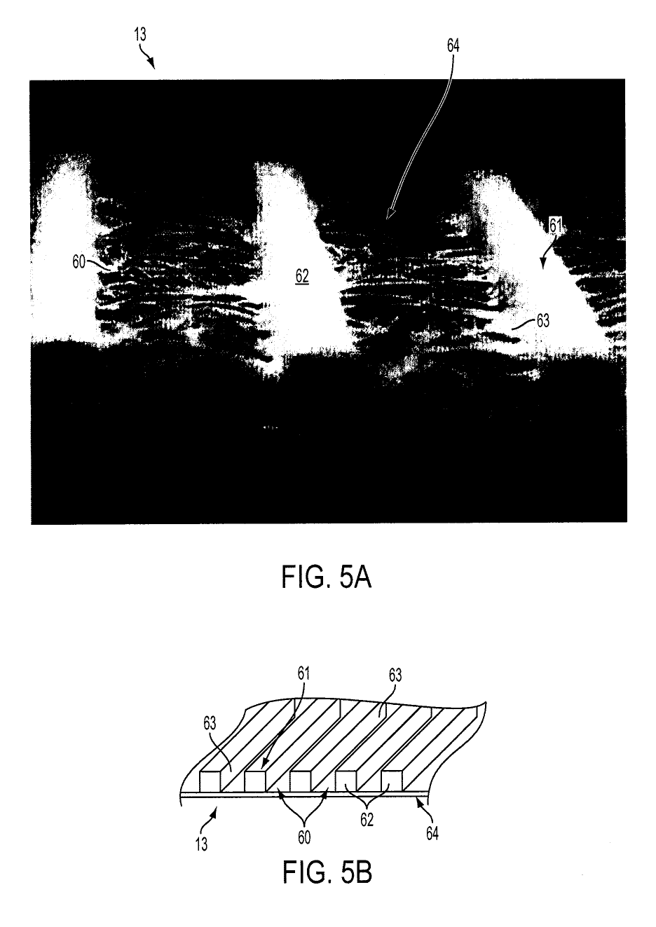

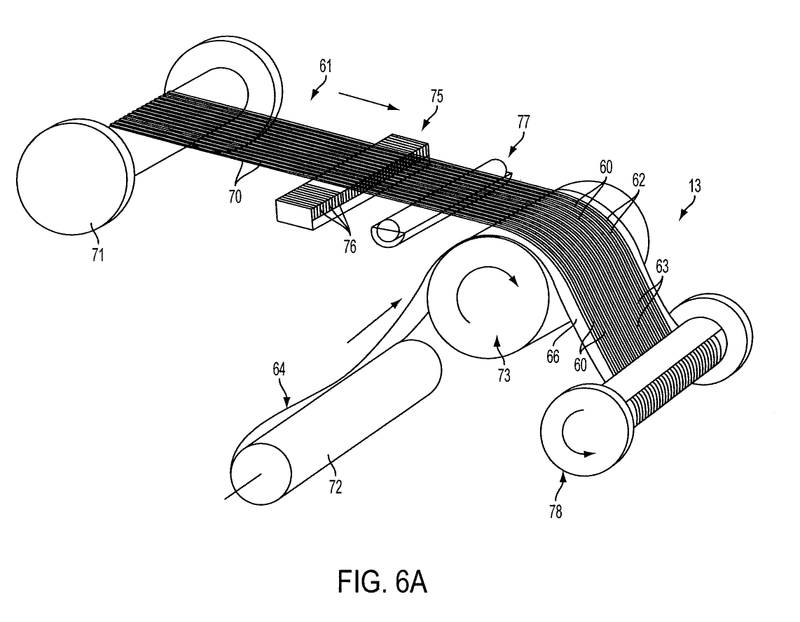

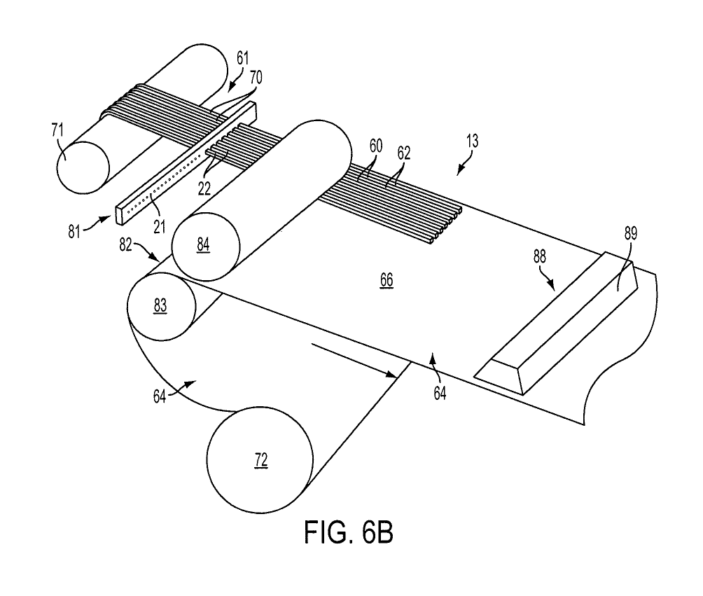

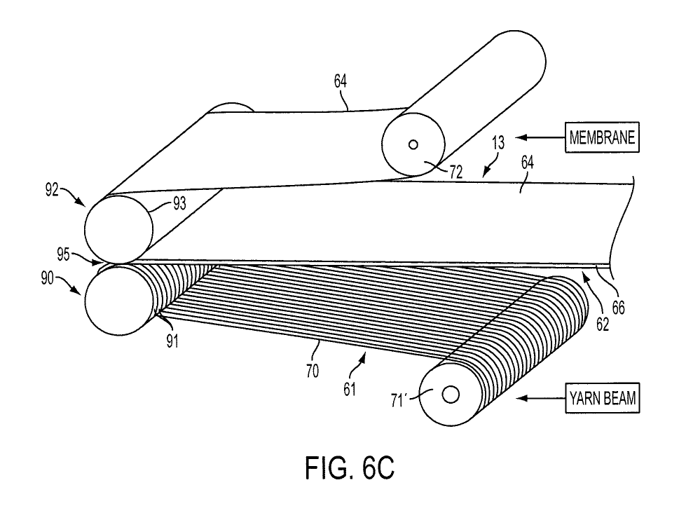

Referring now to the drawings in which like numerals indicate like parts throughout the several views, FIGS. 1-5B generally illustrate example embodiments of a cross-flow core tube 10 (FIGS. 2-4) and permeate carrier sheet materials 13 (FIGS. 5A-5B), for construction of an improved filter element 11 (FIG. 1) for use in a fluid filtration system, according to the principles of the present invention. FIGS. 6A-6C show methods of forming the permeate carrier sheet materials with increased efficiency and without requiring specialized knitting machinery to form the permeate carrier sheet materials, which are adapted to facilitate liquid and gas transference between a permeable of semi-permeable membrane filtration medium and an exit point of the filtration system defined by the core tube 10.

The core tube and permeate carrier sheet materials of the present invention further are adapted for use in a variety of different type liquid or gas filtration and/or transference processes, including reverse osmosis filtration, nano-filtration, ultrafiltration, forward osmosis filtration, and other types of filtration systems, including high and low pressure filtration systems as will be understood by those skilled in the art. The core tube and permeate carrier sheet materials also can be formed in a variety of sizes and/or configurations for use in various filtration applications, including, for example, use in small scale, personal use filtration such as under-sink filter elements in homes and businesses such as for filtering drinking water, and/or use in larger scale filtration of various fluids such as, for example, desalination or cleaning of other contaminated fluid flows.

In further alternative uses, the core tube 10, permeate carrier sheet materials 13 and filter element 11 incorporating such a core tube and permeate carrier sheet materials formed according to the principles of the present invention can be used in other applications, such as in the medical field, including use in dialysis treatments, where the filtered liquid is the permeate product and the removed concentrate is waste, or in applications where the filtered water is the waste and the concentrate removed therefrom is the desired end product, i.e., orange juice, wine, natural gas, etc. The core tube and permeate carrier sheet materials of the present invention are designed to facilitate efficient flow of cleaned fluids such as filtered water and other liquids through the filter element in which the core tube is utilized by enabling more efficient, direct fluid flows through the longitudinal channels of the permeate carrier sheet materials of the filter element without requiring lateral flows of the fluid for collection and removal thereof.

As illustrated in FIG. 1, the filter element 11, here shown in one example embodiment as a reverse osmosis type filtration system, generally includes one or more layers or sheets of a semi-permeable membrane material 12, permeate carrier sheet materials 13 and spacers 14, arranged in a stacked “leaf” structure 15, wound about the core tube 10. The membrane material 12 generally will be a semi-permeable material and can include a filtering membrane surface or element 16 applied to a woven or non-woven support or base sheet 17 that can include a membrane material formed from a polyester, nylon, polypropylene or other semi-permeable material appropriate for filtering the desired fluid, with the particular membrane sheet being chosen for its permeability to the liquid being filtered, for example water or blood in a hemodialysis filtration application, as will be understood by those skilled in the art. Similarly, the spacers 14 can include conventional spacers, here shown as including a lattice or sheet of a polymeric material defining ribs or supports for supporting and separating the layers of the membrane 12 and permeate carrier sheet materials 13.

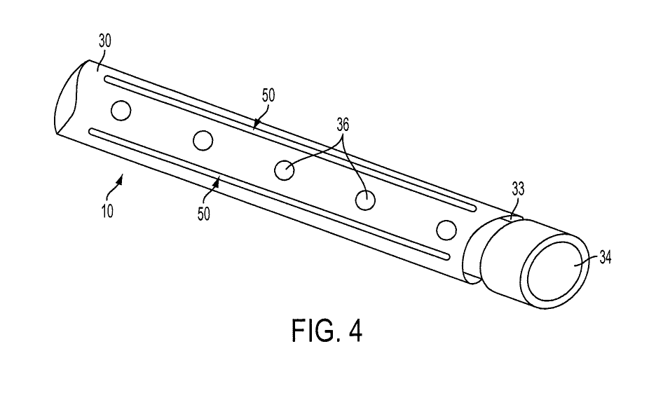

The core tube 10 (FIG. 2) according to the principles of the present invention generally is arranged as a cross flow core tube, typically formed from a rigid, high-strength material such as a polypropylene, polyethylene or other non-leaching synthetic material. The core tube generally includes a tubular body 30, which can be cylindrical, rectangular or of various other configurations as needed or desired, with opposite ends 31 and 32. A glue collection groove 33 generally is formed at each end 31/32 of the core tube body to facilitate collection of the sealing material applied to the ends of the filter element to ensure that an overlap seal is formed between the edges of the permeate carrier sheet materials, membrane sheets spacers and the core tube. This glue collection groove 33 further limits the active area of the cross-flow core tube and filter elements and helps control the flow of the sealing material entity into the filter element. The core tube can be formed at varying lengths and diameters or widths depending upon the filtration application for which the filter element will be used. The diameter or width of the core tube defines the size of an internal flow passage 34 (FIG. 3) through which the permeate will flow for discharge from the filter element. One end 32 (FIG. 2) of the core tube 10 further can include sealing grooves 35 for the receipt of O-rings or similar sealing materials for connection of the core tube to a discharge line or system for removal and/or collection of the permeate from the cross-flow core tube.

As further illustrated in FIGS. 1 and 2, the core tube 10 is formed with a series of flow openings 36 formed at spaced locations along the length of the body 30 of the core tube. In typical reverse osmosis filtration systems, such as for a home water filtration or “under sink” filtration system, there generally are approximately five flow openings per approximately ten inch membrane width. The permeate carrier sheet materials used in such reverse osmosis filtration systems further typically can have approximately 30-34 channels per inch of width of the carrier sheet, and accordingly generally must include lateral or cross flow channels to permit lateral flow so that the permeate flowing along the numerous channels of the permeate carrier sheet materials can reach the flow openings of conventional core tubes.

As shown in FIGS. 1 and 2, the core tube of the present invention further includes a longitudinally extending flow directing groove or flow recess 40 extending substantially along the length of the body 30 of the core tube 10. One or more such flow recesses 40 can be formed in the body of the core tube, with additional flow recesses being spaced at substantially equidistant spacings about the circumference or length and width of the core tube. The flow openings 36 for the core tube generally will be formed or located at spaced positions along the length of the flow recess(es) 40 so as to maintain the pressure differential being applied therethrough for drawing the permeate along the permeate carrier sheet materials. The flow recess(es), however, further enable the permeate to be drawn longitudinally along the length of the permeate carrier sheet material channels 60 (FIG. 1), without requiring cross flow between the permeate carrier sheet material channels since the permeate can be drawn to longitudinally extending flow recess(es) and thereafter will be conveyed laterally along the flow recess to the nearest flow opening. This enables the permeate carrier sheet materials to be formed with substantially longitudinally extending flow channels and without requiring lateral cross flow channels, enabling different type/configuration and less expensive permeate carrier sheet materials to be utilized.

FIG. 3 shows alternative embodiments of the flow recesses 40′, including the use of slotted recesses 41 and shorter recesses with more tightly arranged flow openings. In such alternative embodiments, and in particular with use of the slotted recesses, the slotted recesses typically will be of a smaller length than the flow recess(es) 40 illustrated in FIG. 2, however, they are generally in the additional slotted recesses arranged in spaced locations about the core tube to facilitate removal of the permeate from the filter element. The flow openings 36 also could be formed as slotted openings of a lesser length than the flow recesses and spaced therealong.

FIG. 4 illustrates still a further alternative embodiment of the cross-flow core tube 10 according to the principles of the present invention. In this embodiment, a pair of ridges or ledges 50 is shown in positions bordering or surrounding the flow openings 36. While pairs of ledges are shown, it is also possible to use a single ledge or ridge between each set of flow openings 36. The ledge(s) or ridge(s) help capture and redirect the permeate flow from the flow channels of the permeate carrier sheet materials toward the flow openings for collection and removal. The core tube further could be formed with other raised areas or projections 50, or otherwise could be formed with an “out-of-round” configuration to provide a means for capturing and redirecting the permeate flows to the flow openings.

As indicated in the drawings, such as at FIGS. 5A-6C, the permeate carrier sheet materials 13 formed according to the present invention generally will include a series of channels or grooves 60 formed between various yarn, string, or resinous rib materials 61 that form ribs or wales 62 (FIGS. 6A-6C) defining upstanding channel walls 63, and which can be bonded or otherwise attached/affixed to a substrate 64. In use, these ribs 62 formed and/or mounted or bonded to a surface 66 of the substrate of the permeate carrier sheet materials will support and separate the obverse side of the semi-permeable membrane 12 (FIGS. 1A and 5B), with the membrane and permeate carrier sheet materials generally being arranged in a concentric wound or a spiral wound type arrangement, such as illustrated in the filter element 11 of FIG. 1. The channels defined between the ribs provide a path of reduced resistance for facilitating the exit of the filtered water or gas (“permeate”) from the filter system by providing an unobstructed path between the membrane and channels. As a result, these channels or grooves will allow the permeate liquid or gas being filtered to flow between filtration membrane(s), while the ribs provide adequate support to the membranes, enabling the membrane(s) to resist collapse or structural compression in response to the pressures created during a filtration process.

In addition to conventional permeate carrier materials, such as formed from tricot fabrics, the filter element formed according to the principles of the present invention can further include permeate carrier sheet materials that are different in structure and method of formation from conventional tricot materials so as to create a more economical permeate carrier sheet material. In one example embodiment, such as shown in FIGS. 5A-6C, the permeate carrier sheet materials 13 of the present invention can be formed as a composite material including a substrate or base layer 64 that can be formed from a polymeric membrane material, and to which a series of spaced yarns, strings, filaments, ribbons, strips, lines of a resin material, or other, similar rib materials 61 can be applied.

Examples of suitable materials that can be utilized for the membrane base layer or substrate 64 of the permeate carrier sheet materials can include woven or non-woven polymeric materials, such as a polyester, polypropylene or other membrane materials as well as various types of epoxies or resinous materials. The rib materials 61 applied to the substrate generally can comprise thermoplastic polymeric yarns or strings, typically formed from various polymers, such as polyethylene sheath/polypropylene core monofilament yarns, polyester/polypropylene spun yarns, polyester-ethylene, vinyl acetate, acrylonitrile, butadiene, styrene or other types of monofilament, bi-component or multi-component yarns capable of being thermo-set or thermally bonding to the substrate material.

Alternatively, measured rows of resinous or other synthetic or polymeric materials also can be extruded and/or deposited on the substrate in discrete lines, with a desired spacing therebetween to form the ribs as discussed below. The yarns, strings, resin material lines or other materials utilized for the rib materials further can range in sizes from approximately 0.10 mm up to approximately 1 mm, although greater or lesser size strips, lines or yarns also can be used as needed or desired depending on the filtration application for which the permeate carrier sheet materials will be used.

Accordingly, the formation of the permeate carrier sheet materials can be controlled to form different permeate carrier sheet materials with different size yarns and/or different materials form varying rib/wale and channel configurations and sizes to define different properties, such as varied desired flow or filtration characteristics of the filter element utilizing the permeate carrier sheet materials, depending on the type of filtration system and/or the environment in which the further element is to be used. By way of example, and not limitation, one example embodiment of the permeate carrier sheet material could comprise rib materials formed from a 10/1 or higher cotton content polyester/polypropylene spun yarn applied to a woven or non-woven membrane substrate, such as a 20-40 gsm spun bond polypropylene membrane. Alternatively, the rib materials could include a synthetic spun yarn, such as polyester or polyethylene sheath/polyester/polypropylene core yarn having a size of approximately 0.2 mm-1 mm, though larger or smaller sizes also could be used, applied to a spun bond polypropylene or a polyester/nylon nonwoven membrane.

As illustrated in FIGS. 5A-6C, in various examples of preferred embodiments of processes for forming the permeate carrier sheet materials 13 of the present invention, yarns 70, filaments or strings are shown as being used for the rib materials. These yarns 70 can be fed from a feed roll 71 (FIGS. 6A-6B) yarn beam 71′ (FIG. 6C) or creel into engagement with the substrate or membrane material 64, in an overlying relationship along the surface 66 of the substrate, which likewise generally will be fed from a supply roll 72, with the two materials being brought into registration by one or more guide rolls 73. Various other rib materials also can be used and applied in similar operations as will be understood by those skilled in the art.

In the embodiment shown in FIG. 6A, the yarn guide can comprise a guide reed 75 having a series of guide slots 76 through which the yarns 70 are fed. Alternatively, a toothed comb or other, similar yarn guide can be used for guiding the yarns with a desired/predetermined spacing therebetween, toward engagement with the substrate. The yarns are guided in spaced series across a kiss-roll coating roller 77, or other adhesive applicator, that can apply molten polymer resin adhesive material to the yarns to provide adhesion of the yarns to the substrate 64. After the yarns pass over the kiss-roll coating roller, they are engaged by and are applied to the surface 66 of the substrate being fed from its supply to a guide roll 72 (which also can be heated or cooled as needed) to help adhesion of the polymer coated yarns to the substrate. The substrate, with the yarns applied/adhered in spaced rows or series thereto, is then fed about a wind-up roll 78, which can be driven to help provide a tension to the substrate and yarns as they are brought into registration. This tension helps urge the polymer coated yarns and the substrate together and promotes adhesion therebetween, without necessarily requiring the use of a pressure applicator such as nip rolls to create such adhesion between the yarns and substrate.

Alternatively, as shown in Fib. 6B, the rib materials 61, such as yarns/strings or other rib materials, could be fed from a supply through a yarn guide 81, such as a reed or similar guide, and into engagement with the membrane/substrate 66 at the nip 82 between a pair of nip or compression rolls 83/84. This guide 81 can include an elongated body 86 with a series of holes or passages 87 defined therethrough and arranged at a desired spacing as indicated in FIG. 6B. The compression rolls also can be heated, for example to between about 130° C.-250° C., or to greater or lesser temperatures, as needed to soften the polymeric yarns/strings and/or the membrane material of the substrate to an extent sufficient to promote adhesion of the yarns/strings to the substrate as the composite carrier material is compressed together between the compressor rolls. Thereafter, as the composite yarn/string and membrane material/substrate of the permeate carrier sheet materials is moved further downstream, it can pass through a cooling zone, generally indicated at 88 and which can have a cooling fan or blower 89, or about cooling roller that will allow the yarns to bond to the substrate while maintaining their spacing on the substrate.

In still a further embodiment of the process illustrated in FIG. 6C, the rib materials 61, such as yarns 70 generally will be fed around a heated grooved roll 90, which can have a series of individual grooves or channels 91 formed therein, each of which is adapted to receive a yarn 70 therein. The grooves or channels will be spaced apart by a desired distance so as to form a spacing between the yarns of the desired distance, such that after the yarns or strings are attached to the substrate 64, they will be spaced apart to define the channels 60 of the finished permeate carrier sheet materials 13.

In addition, the grooves of the grooved roll through which the yarns are passed can be sized and shaped so as to form a specific desired shape for the channel ribs 62, such as a substantially square or rectangular configuration as illustrated in FIG. 5B. The substrate of permeate carrier sheet materials generally will be fed around a smooth guide roll 92 (FIG. 6C), typically having a heated surface 93 for preheating the membrane material of the substrate. The rib materials and membrane material are fed into registration with each other and are then passed through the nip 95 of the heated rollers 90/92, so that the rib materials are guided into registration with and are applied to the base material in a substantially consistent and even fashion with the rib materials generally being spaced across the width of the membrane to define the necessary channels of the permeate carrier sheet materials.

As noted, the grooves of the yarn roller shown in FIG. 5C, or the yarn guide or reed shown in FIGS. 5A-5B, generally will be sized and configured to provide a desired rib geometry and spacing for the rib material. Typically, such spacing can be within a range of approximately 20 to 80 ribs per inch. It will, however, be understood that other spacings or arrangements of the rib materials also can be used depending upon the application in which the permeate carrier sheet materials is to be used. Additionally, various rib/channel configurations can be provided. For example, the rib material can be formed as substantially flat topped ribs with substantially straight, smooth sides to provide a more consistent and even support for the subsequent semi-permeable membrane attached or applied thereover, and to provide a substantially unrestricted a flow channel between the ribs, such as shown in FIGS. 6B-6C. However, other rib configurations or arrangements also can be provided as needed or desired depending upon the application.

The height, width and spacing of the ribs of the permeate carrier sheet materials further can be adjusted to meet the desired pressure and flow requirements for each particular filtration application for which the permeate carrier sheet materials is to be used. Still further, the temperature of the heated rollers or adhesive coater/applicator can also be adjustable so as to match the thermoplastic properties of the desired rib and substrate materials in use to facilitate a substantially smooth transfer and maximum adhesion of the rib material to the substrate without the rib material becoming unduly softened or melted and/or sticking to the rollers.

In another, alternative embodiment, the rib materials can be applied in the form of a molten polymeric resin or other similar material that can be extruded or otherwise applied to the substrate at a predetermined spacing and thickness. In such a system, one or more extrusion heads will be mounted above a web or substrate for applying an extruded resinous or polymeric material such as a molten polyester, polypropylene, acrylonitrate, butadiene, styrene or epoxy material, which passes downstream through a heated grooved roll that will form and can assist in curing the extruded rows of the polymeric material into the ribs of a desired shape, thickness, alignment, and spacing. It is also possible for the extrusion nozzles to apply the molten rib material in discrete lines that will substantially form the ribs upon cooling, with the discrete lines of the molten rib material being arranged at a desired spacing and with the amount of molten material being applied being controlled as to form ribs of a desired shape, height and/or width.

The permeate carrier sheet materials, membrane sheet and spacers further can be given a generally desired weight as needed for the particular filtration application to which the filter element 11 is to be used. For example, the permeate carrier sheet materials and membrane sheets can each have a weight of approximately 1-10 ounces per square yard, although greater or lesser fabric weights also can be used depending upon the filtration application. Additionally, the permeate carrier sheet materials and membrane sheets further can have thicknesses ranging from approximately 5-40 mil, and preferably approximately 10-30 mil, although other varying ranges of thicknesses also can be utilized, and will define longitudinal flow channels of a size as needed or desired depending upon the filtration application.

As illustrated in FIG. 1, the filter element 11 can be constructed including multiple leaf structures 15 of membrane sheets 12, permeate carrier sheet materials 13 and spacer elements 14, generally arranged in a stacked or sandwiched configuration and substantially spirally wound about the cross flow core tube 10 of the present invention, thus forming the spiral wound filter element 11. As will also be understood, a single membrane sheet, single permeate carrier sheet and single spacer element sheet can be arranged in a stacked configuration, and thereafter folded and/or wound about the core tube to form the spiral wound filter element. For example, in an under-sink filtration system, a permeate carrier sheet of approximately 45-48 inches, a membrane sheet of approximately 40-45 inches and a feed channel spacer sheet can be wound about a core tube to form the filter element for use in an under-sink filtration type system.

Each leaf structure 15 of the filter element 11 generally will be formed by placing a permeate carrier sheet material between 2 semi-permeable membrane sheets 12 with the base sheets 16 of the membrane sheets in contact with the permeate carrier sheet and the membrane surface facing outwardly therefrom. The permeate carrier sheet material further generally is of an extended length so as to extent beyond the membrane sheets in a flow length or direction. The interior, aligned side edges 20 of the membrane sheets and the permeate carrier sheet material defining each leaf generally are closed by an adhesive or other sealing material before or during the winding process, with the remaining open side of each leaf directed toward the cross-flow core tube 10. Thereafter, spacer elements 14 can be inserted between the leaves, or adjacent a leaf, and the assembly wound or wrapped about the cross-flow core tube.

In one example embodiment of the present invention, in forming the filter element with the cross-flow core tube of the present invention, as discussed above, the permeate carrier sheet materials generally are located between two semi-permeable membranes, with one or more spacer elements being applied to the membranes to form a “leaf” of a spiral wound filter element, where the leaf structure is edge sealed with a sealing material on both sides and typically at the opposite or trailing end of the leaf structure. The filter element further generally can consist of one or more leaf structures that are wound about the core, with the feed channel spacer materials being applied therebetween so as to provide a cross flow path for feed water from the outside of the leaf. The exposed end of the permeate carrier sheet material then is initially wound about the core tube, typically in two or more wrappings or windings thereof and the leaf structure(s) are further wound about the core tube to form the filter element. The filter element generally will be placed within a containment vessel, and can also include a brine seal placed thereabout to prevent bypass of the filter element by the influent fluid flow.

Additionally after winding of the leaves to form the filter element 11, a cover sheet 25 can be applied over the filter element, covering and sealing the stacked, spirally wound membrane and permeate carrier sheet elements and spacers. Alternatively, or in addition, as indicated in FIG. 2, the filter element can be housed within a tube or other similar housing (shown in phantom at 26), with the filter element projecting outwardly from a gasket or brine seal 27 that is placed in a sealing arrangement about the filter element, engaging the filter housing or containment vessel to help prevent the influent flow of water by passing filtration through the filter element. In use, the influent flow comes into the filter at an infeed pressure and passes through the filter portions of the membrane sheets and along the flow channels of the permeate carrier sheet materials to the core tube 10 for collection and removal of the permeate.

In use, the ends of the core tube generally will protrude from the ends of the filter element and will be connected to a discharge tube or system for removal of the permeate collected within the central flow passage of the core tube. Typically, the core tube is at atmospheric pressure while the influent fluid is at a feed pressure that urges or directs the influent fluid flow through the filter element sheets or leaves and to the flow openings of the core tube. As a result, the filtered permeate is drawn through the semi-permeable membrane and into and along the longitudinally aligned flow channels of the permeate carrier sheet material. As the permeate reaches the flow recess(es) formed in the core tube, the permeate flows into and is collected at the flow recess(es) of the cross-flow tube. Thereafter, the permeate will then be drawn laterally along the length of the flow recess and into the nearest flow opening and into the flow passage for removal.

As a result, the permeate carrier sheet materials are not required to have lateral flow channels or to be otherwise configured so as to enable lateral passage of the permeate flows across the permeate carrier sheet materials. Instead, the permeate can be drawn more efficiently along the longitudinal flow passages rather than being diffused across the width/expanse of the permeate carrier sheet materials. The core tube further could be used with conventional permeate carrier sheet materials including woven or knitted fabric or tricot materials to provide enhanced or more efficient flow therethrough. Accordingly, the present invention provides a core tube assembly for use in fluid filtration systems that enables the use of less expensive filtration materials and which provides greater efficiency in the removal of the filtered permeate materials from such filtration elements. In addition, the permeate carrier sheet materials formed according to such methods can be constructed in a more economical manner, using various lower cost materials such as yarns, strings, resin materials, and other, similar materials, and with the formation of the ribs or wales and channels defined between each of the ribs or wales being controllable to enable for motion of such ribs/wales and fluid flow channels in desired sizes, widths, depths, and/or configurations as needed to accommodate a desired flow rate of the permeate fluid flow therealong.

The foregoing description generally illustrates and describes various embodiments of the present invention. It will, however, be understood by those skilled in the art that various changes and modifications can be made to the above-discussed construction of the present invention without departing from the spirit and scope of the invention as disclosed herein, and that it is intended that all matter contained in the above description or shown in the accompanying drawings shall be interpreted as being illustrative, and not to be taken in a limiting sense. Furthermore the scope of the present disclosure shall be construed to cover various modifications, combinations, additions, alterations, etc., above and to the above-described embodiments, which shall be considered to be within the scope of the present invention. Accordingly, various features and characteristics of the present invention as discussed herein may be selectively interchanged and applied to other illustrated and non-illustrated embodiments of the invention, and numerous variations, modifications, and additions further can be made thereto without departing from the spirit and scope of the present invention as set forth in the appended claims.

1. A filter element for a fluid filtration system, comprising:
at least one semi-permeable membrane sheet for filtering a fluid flowing into the filter element;
at least one permeate carrier sheet located along a side surface of said at least one membrane sheet, said at least one permeate carrier sheet having a series of ribs formed at spaced intervals therealong and defining a series of channels for directing a filtered fluid away from said at least one membrane sheet; and
a core tube about which said at least one membrane sheet and said at least one permeate carrier sheet are wound, said core tube comprising a body having a central flow passage defined therealong, at least one flow recess extending along at least a portion of said body, and at least one flow opening in said body, located along said at least one flow recess;
wherein the filtered fluid directed along said channels of said at least one permeate carrier sheet is collected at said at least one flow recess extending along at least a portion of said body, and flows to and through said at least one flow opening and into said central flow passage for discharge of the filtered fluid from the fluid filtration system.

2. The filter element of claim 1 and further including at least one spacer positioned along an opposite side of said at least one membrane sheet from said at least one permeate carrier sheet.

3. The filter element of claim 1 and wherein said core tube includes at least two flow recesses arranged on opposite sides of said core tube.

4. The filter element of claim 1 and wherein said flow openings comprise 2 to 6 holes formed at spaced intervals along a length of said at least one flow recess.

5. The filter element of claim 1 and wherein said at least one flow recess comprises a slotted opening extending at least partially along said at least one flow recess.

6. The filter element of claim 1 and further comprising a plurality of membrane sheets, a plurality of permeate carrier sheets, and a series of spacers arranged in stacked series and spirally wound about said core tube, and a cover applied to said spirally wound membrane sheets, permeate carrier sheets and spacers.

7. The filter element of claim 2 and further comprising a sealing material applied to at least one end of said spirally wound membrane sheets, permeate carrier sheets and spacers.

8. The filter element of claim 7 and wherein said core tube further comprises a collection groove formed adjacent an end of said core tube at said at least one end of said spirally wound membrane sheets, permeate carrier sheets and spacers to which said sealing material is applied.

9. The filter element of claim 1, wherein said permeate carrier sheet comprises a substrate and wherein said series of ribs are applied to said substrate in discrete rows arranged at their spaced intervals and bonded to said substrate.

10. The filter element of claim 9, wherein said ribs are bonded in said substrate by an adhesive, resin or application of heat thereto.

11. The filter element of claim 9, wherein said ribs are applied to said substrate as extruded structures of a synthetic, plastic or resin material.

12. The filter element of claim 1, wherein said permeate carrier sheet comprises a series of yarns or strings fed in spaced series into an overlying relationship onto a surface of a substrate and affixed thereto, said yarns or strings being selectively spaced so as to form said ribs and define said channels therebetween, with said channels having a desired configuration extending along said permeate carrier sheet.

13. A filter element comprising:
at least one semi-permeable membrane sheet for filtering a fluid flowing into the filter element;
at least one permeate carrier sheet located along a side surface of said at least one membrane sheet, said at least one permeate carrier sheet having a series of rib materials selectively applied to a substrate at spaced intervals therealong and defining a series of fluid flow channels for directing a filtered fluid away from said at least one membrane sheet; and
a core tube about which said at least one membrane sheet and said at least one permeate carrier sheet are wound, said core tube comprising a body having a central flow passage defined therealong, one flow opening said body, located at spaced intervals wherein the filtered fluid directed along said channels of said at least one permeate carrier sheet is collected and flows to and through said at least one flow opening and into said central flow passage for discharge of the filtered fluid from the fluid filtration system.

14. The filter element of claim 1 and further including at least one flow directing groove extending along at least a portion of said body and wherein said flow openings are arranged along said flow directing groove.

15. The filter element of claim 14 and wherein said core tube includes at least two flow directing grooves arranged on opposite sides of said core tube.

16. The filter element of claim 14 and wherein said flow openings comprise 2 to 6 holes formed at spaced intervals along a length of said at least one flow directing groove.

17. The filter element of claim 14 and wherein at least one of said flow openings comprises a slotted opening extending at least partially along said at least one flow directing groove.

18. The filter element of claim 14 and wherein said permeate carrier sheet comprises a series of yarns or strings fed in spaced series into an overlying relationship onto a surface of a substrate and affixed thereto, said yarns or strings being selectively spaced so as to form said ribs and define said channels with a desired configuration extending along said permeate carrier sheet.

19. The filter element of claim 14, wherein said ribs are applied to said substrate as extruded structures of a synthetic, plastic or resin material.
